(19) United States
(12) Patent Application Publication
(10) Pub. No.: US 2012/0163311 A1
(43) Pub. Date: Jun. 28, 2012

(54) DATA TRANSMISSION METHOD FOR USE IN MOBILE COMMUNICATION SYSTEMS

(75) Inventor: Hyun Seo PARK, Daejeon (KR)

(73) Assignee: Electronics and Telecommunications Research Institute, Daejeon (KR)

(21) Appl. No.: 13/332,311

(22) Filed: Dec. 20, 2011

(30) Foreign Application Priority Data
Dec. 22, 2010 (KR) 10-2010-0132888

(51) Int. Cl. H04W 72/04

(52) U.S. Cl. 370/329

(57) ABSTRACT

Disclosed is a data transmission method for use in mobile communication systems that can rapidly transmit a small amount of data and improve the performance of the entire system by reducing signaling overhead. A machine-type communication (MTC) terminal transmits a random access preamble message to a base station after selecting a predetermined preamble from a preamble group. The MTC terminal receives a random access response message including uplink (UL) resource allocation grant information from the base station. The MTC terminal performs scheduled transmission including data on the basis of the UL resource allocation grant information.

### CLAIM FOR PRIORITY

This application claims priority to Korean Patent Application No. 10-2010-0132888 filed on Dec. 22, 2010 in the Korean Intellectual Property Office (KIPO), the entire contents of which are hereby incorporated by reference.

### BACKGROUND

1. Technical Field

Example embodiments of the present invention relate to data transmission of mobile communication systems, and more particularly, to a data transmission method for use in mobile communication systems that may be applied to a terminal, which transmits a small amount of data.

2. Related Art

Machine-type communication (MTC) or machine to machine (M2M) communication is data communication related to one or more entities that do not necessarily include human intervention.

MTC service is a communication field that is rapidly growing all over the world, and is defined in the development direction of next-generation mobile communication technology, even in a mobile communication standard organization such as 3rd Generation Project Partnership (3GPP).

MTC service utilizing mobile communication is ongoing and being utilized in various fields. At present, MTC service fields widely using mobile communication are telematics, security, automatic meter reading (AMR), payment, remote maintenance and control (RMC), and the like, and its range of use is extending to health care or consumer devices.

Characteristics of MTC service in 3GPP different from an existing human-centric communication service have been analyzed to be a) low mobility, b) data transmission/reception only during a defined time (time controlled), c) data transmission delay tolerance (time tolerant), d) priority alarm message, e) dedicated service for packet switching (packet switched only), f) low data communication rate (small data transmission), and the like.

As a noticeable point in variation of a terminal and system according to the MTC service, it shall be possible to rapidly transmit and receive a small amount of data even in an offline state as defined in 5.5.2 of 3GPP Technical Report (TR) 23.888. This means that an MTC server should be able to rapidly receive information transmitted from an MTC terminal using a minimum radio resource and battery.

In particular, the promptness of MTC call processing and data transmission is very important in services such as detection of a gas or water leak in smart metering, or critical condition detection in e-Health such as heart failure, falling, or the like. Accordingly, a cell processing procedure for MTC should be rapidly performed.

However, network connection should be constantly maintained through a radio connection regardless of the amount of data to be transmitted, and connection time according to a basic data transmission/reception procedure defined in a 3GPP long term evolution (LTE) system.

Accordingly, in the case of an MTC terminal having a connection with a network for transmission of a small amount of data during a short period of time, there is a problem in that the amount of signaling data to be transmitted to establish a network connection through a radio connection and its signaling time are greater than the amount of data transmission and its transmission time. In particular, there is a problem in that the overhead as described above may degrade the performance of the entire system when a large number of MTC terminals are considered, and hence degrade the quality of mobile communication service through an existing general user terminal.

### SUMMARY

Accordingly, example embodiments of the present invention are provided to substantially obviate one or more problems due to limitations and disadvantages of the related art.

Example embodiments of the present invention provide a data transmission method for use in mobile communication systems that may rapidly transmit a small amount of data and improve the performance of the entire system by reducing signaling overhead.

In some example embodiments, a data transmission method for use in mobile communication systems includes: transmitting, by a machine-type communication (MTC) terminal, a random access preamble message to a base station after selecting a predetermined preamble from a preamble group; receiving, by the MTC terminal, a random access response message including uplink (UL) resource allocation grant information from the base station; and performing, by the MTC terminal, scheduled transmission including data on the basis of the UL resource allocation grant information.

The data transmission method may further include: determining, by the MTC terminal, whether the data transmission has succeeded by receiving a first message transmitted from the base station after performing the scheduled transmission.

After performing the scheduled transmission, the MTC terminal may receive one of a contention resolution message, a radio link control (RLC) acknowledgement (Ack), and an application-level Ack from the base station.

The transmitting, by the MTC terminal, of the random access preamble message may include: transmitting, by the MTC terminal, the random access preamble message after selecting the predetermined preamble from a dedicated first preamble group allocated to the MTC terminal.

The transmitting, by the MTC terminal, of the random access preamble message may include: transmitting, by the MTC terminal, the random access preamble message after selecting the predetermined preamble from a second preamble group allocated to a general terminal, if data to be transmitted by the MTC terminal is greater than a preset reference value.

The transmitting, by the MTC terminal, of the random access preamble message may include: selecting one of a dedicated preamble group allocated to the MTC terminal and a preamble group allocated to a general terminal by considering at least one of an amount of data to be transmitted by the MTC terminal and a length of a session to be set up.

In other example embodiments, a data transmission method for use in mobile communication systems includes: receiving, by a base station, a random access preamble message from an MTC terminal; transmitting, by the base station, a random access response message including UL resource allocation grant information as a response to the random access preamble message to the MTC terminal; and receiving, by the base station, a scheduled transmission message including data of the MTC terminal from the MTC terminal.

The data transmission method may further include: receiving, by the base station, the scheduled transmission message from the MTC terminal, and transmitting one of a contention resolution message, an RLC Ack, and an application-level Ack to the MTC terminal.

The transmitting, by the base station, of the random access response message may include: allocating, by the base station, a dedicated radio network temporary identifier (RNTI) for the MTC terminal, and generating a radio bearer of the RNTI.

The receiving, by the base station, of the scheduled transmission message may include: transferring, by the base station, the data of the MTC terminal to a core network on the basis of preset bearer mapping information.

### BRIEF DESCRIPTION OF DRAWINGS

Example embodiments of the present invention will become more apparent by describing in detail example embodiments of the present invention with reference to the accompanying drawings, in which:

FIG. 1 is a sequence diagram showing a random access procedure of a general terminal in a 3GPP LTE-advanced system; and

FIG. 2 is a sequence diagram showing a data transmission method according to an example embodiment of the present invention.

### DESCRIPTION OF EXAMPLE EMBODIMENTS

Example embodiments of the present invention are disclosed herein. However, specific structural and functional details disclosed herein are merely representative for purposes of describing example embodiments of the present invention, however, example embodiments of the present invention may be embodied in many alternate forms and should not be construed as limited to example embodiments of the present invention set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention. Like numbers refer to like elements throughout the description of the figures.

It will be understood that, although the terms first, second, A, B, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The term “terminal” may refer to a mobile station (MS), user equipment (UE), a user terminal (UT), a wireless terminal, an access terminal (AT), a subscriber unit, a subscriber station (SS), a wireless device, a wireless communication device, a wireless transmit/receive unit (WTRU), a mobile node, a mobile, or other terms.

The term “base station” generally denotes a fixed point communicating with a terminal, and may be referred to as a Node-B, an evolved Node-B (eNB), a base transceiver system (BTS), an access point, and other terms.

Hereinafter, example embodiments of the present invention will be described in detail with reference to the accompanying drawings. To understand the invention easily, the same elements are designated using the same reference numerals, and redundant description thereof is omitted.

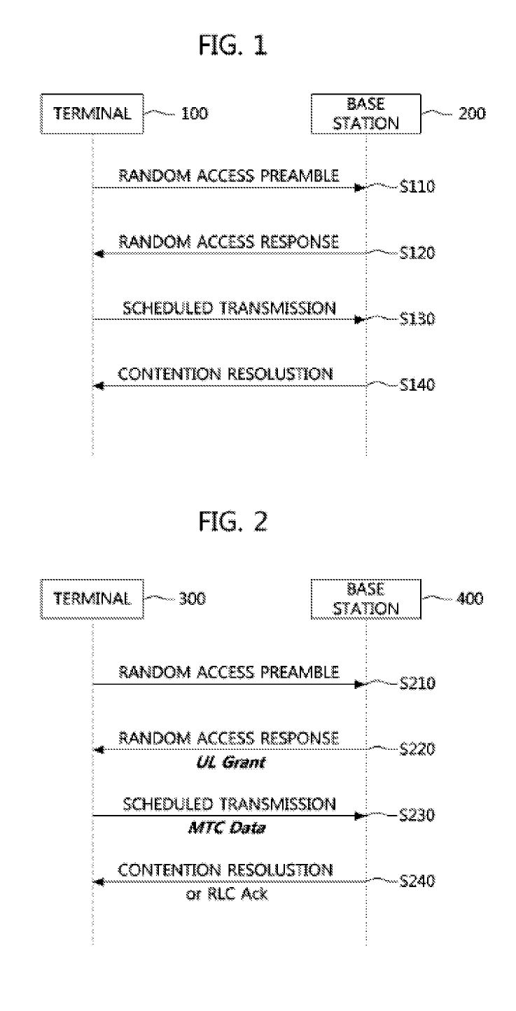

FIG. 1 is a sequence diagram showing a random access procedure of a general terminal in a 3GPP LTE-advanced system.

The random access procedure is a process necessary for a terminal to establish a connection to a network, and is performed for an initial connection, a handover, a scheduling request, UL time synchronization acquisition, or the like. That is, all terminals have random access for initial connection and data transmission.

The random access procedure may be divided into a contention-based access procedure and a non-contention-based access procedure. The contention-based access procedure is shown in FIG. 1.

The contention-based random access procedure is a technique of selecting and using an arbitrary one of a plurality of random access preambles to be commonly used. During the contention-based random access procedure, a collision with other terminals may occur.

The random access procedure will be described with reference to FIG. 1. A terminal 100 randomly selects a random access preamble using random access-related system information previously received from a base station 200, and transmits the selected random access preamble to the base station 200 (S110).

The base station 200 receives the random access preamble transmitted by the terminal 100, and transmits a random access response as its response to the terminal 100 (S120).

If the terminal 100 has successfully received the random access response to its own transmitted random access preamble, the terminal 100 performs scheduled (UL) transmission using a UL radio resource allocated from the base station 200 so as to establish a radio resource control (RRC) connection (S130).

The base station 200 transmits a contention resolution message corresponding to the scheduled transmission from the terminal to the terminal 100. If the terminal 100 receives the content resolution message, the random access procedure is completed.

In the case of the MTC service, a number of MTC terminals may simultaneously perform the above-described random access procedure due to unique characteristics of the MTC service. In addition, when the MTC terminal has a connection in a 3GPP LTE system, the MTC terminal should contend with a general user terminal when using the procedure as shown in FIG. 1 to be used by the general user terminal.

That is, when selecting a random access preamble, the general user terminal designates a group to be selected using information received through system information, and establishes a connection to the base station by designating a value at random.

Here, in relation to system information including information regarding the random access preamble selection, the base station includes common channel-related information and overall information regarding a system in the system information in the 3GPP LTE system, and transmits the system information to terminals through a common broadcast channel.

The system information is configured in the form of a system information block (SIB). Each SIB includes a series of functionally related parameters. Here, SIBs may be divided into a master information block (MIB) including a limited number of parameters that are most frequently transmitted as parameters necessary for a terminal to have an initial connection to a network, SIB 1 (SIB type 1) including parameters necessary to determine whether a cell to be selected is appropriate and information related to time domain scheduling of other SIBs, SIB 2 including channel information to be commonly shared, and the like according to their characteristics.

SIB segmentation and concatenation are performed in an RRC layer, and scheduling of a transmission cycle or method or the like, is managed by grouping SIBs having similar characteristics.

After receiving the above-described system information, the terminal sets up a channel, analyzes information regarding a random access channel so as to perform initial random access, selects one of possible random access preambles, and initiates the random access procedure.

FIG. 2 is a sequence diagram showing a data transmission method according to an example embodiment of the present invention.

FIG. 2 shows a process in which a terminal, such as an MTC terminal, for transmitting a small amount of data transmits data without setting up an RRC connection, and terminates a communication session in a mobile communication system including LTE and LTE-advanced systems. Hereinafter, the terminal shown in FIG. 2 is assumed to be an MTC terminal.

Referring to FIG. 2, first, an MTC terminal 300 transmits a random access preamble to a base station 400 (S210). Here, when transmitting a small amount of data once in consideration of the amount of MTC data to be transmitted and session characteristics, and terminating a communication session, the MTC terminal 300 transmits a random access preamble to the base station 400 by selecting an arbitrary preamble from a dedicated preamble group allocated to the MTC terminal.

Alternatively, when an amount of data to be transmitted is large, or a communication session should be maintained for a long time, the MTC terminal 300 may transmit a random access preamble to the base station 400 by selecting an arbitrary preamble from a preamble group allocated to a general user terminal. In the case as described above, data is transmitted after an RRC connection is established and a network connection is maintained according to a communication method defined in an existing LTE or LTE-advanced system.

The MTC terminal compares a reference value preset for selecting the preamble group as described above to the amount of data to be transmitted. If the amount of data to be transmitted is less than the above-described reference value, the MTC terminal selects a preamble from its dedicated allocated preamble group. If the amount of data to be transmitted is greater than the above-described reference value, the MTC terminal may select a preamble from a preamble group allocated to a general user terminal.

The base station 400 transmits a random access response message as a response to the random access preamble received from the MTC terminal 300 to the MTC terminal 300 (S220). Here, the random access response message includes UL resource allocation information, or UL grant information through which the MTC terminal 300 may transmit MTC data.

The base station 400 receiving the preamble included in the preamble group allocated to the MTC terminal transmits the random access response message. At this time, when a normal random access response message is transmitted, a dedicated radio network temporary identifier (RNTI) for the MTC terminal 300 is allocated, and a radio bearer of the RNTI is generated. Here, the radio bearer of the RNTI for the MTC terminal 300 is mapped to a preset bearer from the base station to a core network.

The MTC terminal 300 receives the random access response message transmitted from the base station 400, and transmits MTC data to the base station 400 using a UL grant of a UL resource allocated for a predetermined time corresponding to the random access response message (S230). Here, although scheduled data to be transmitted by the MTC terminal 300 includes information for RRC connection setup for the general user terminal, MTC data is directly included and transmitted without RRC connection information in the data transmission method according to an example embodiment of the present invention.

The base station 400 receiving scheduled data including MTC data transfers the MTC data to the core network on the basis of preset bearer mapping information. The MTC data transferred to the core network is transferred to each MTC application server through an MTC service gateway (GW).

In addition, the MTC terminal 300 transmitting the MTC data needs to determine whether the MTC data has been normally transmitted. For this, after transmitting the MTC data, the MTC terminal 300 may terminate a communication session after waiting for a first message to be transmitted from the base station 400.

In order to indicate whether the MTC data transmitted by the MTC terminal 300 has been normally received, the base station 400 may transmit a contention resolution message, which is transmitted to the general user terminal, or transmit an RLC Ack message by setting a dedicated logical channel identifier (LCID) for MTC in an RLC acknowledged mode (AM). Alternatively, an MTC server may transmit an application-level Ack such as a transmission control protocol (TCP) Ack indicating whether the MTC data has been received, to the MTC terminal 300 (S240). Through this, the MTC terminal 300 determines whether the MTC data has been successfully transmitted, and terminates the communication session. Here, when determining that the MTC data has not been normally transmitted, the MTC terminal 300 may retransmit the MTC data.

For the MTC terminal to transmit the MTC data without an RRC connection as shown in FIG. 2, a dedicated preamble group for the MTC terminal is allocated, a dedicated RNTI for the MTC terminal is allocated, and a dedicated LCID for the MTC terminal for determining whether the MTC data transmitted from the MTC terminal has been successfully transmitted (RLC Ack) is allocated, in an example embodiment of the present invention. The above-described requirement is additionally applied to a communication method of the LTE and LTE-advanced systems.

According to the data transmission method for use in mobile communication systems as described above, for an MTC terminal having a network connection during a short period of time for transmission of a small amount of data, data may be directly transmitted in a state in which no network connection is established through a radio connection, so that it is possible to reduce signaling data transmission overhead and shorten a signaling time.

In addition, it is possible to prevent the degradation of system performance due to a network resource occupied by signaling traffic used by an MTC terminal for a network connection, and reduce a transmission delay time of the MTC terminal.

While the example embodiments of the present invention and their advantages have been described in detail, it should be understood that various changes, substitutions and alterations may be made herein without departing from the scope of the invention.

What is claimed is:

1. A data transmission method for use in mobile communication systems, comprising:
transmitting, by a machine-type communication (MTC) terminal, a random access preamble message to a base station after selecting a predetermined preamble from a preamble group;
receiving, by the MTC terminal, a random access response message including uplink (UL) resource allocation grant information from the base station; and
performing, by the MTC terminal, scheduled transmission including data on the basis of the UL resource allocation grant information.

2. The data transmission method of claim 1, further comprising:
determining, by the MTC terminal, whether the data transmission has succeeded by receiving a first message transmitted from the base station after performing the scheduled transmission.

3. The data transmission method of claim 2, wherein, after performing the scheduled transmission, the MTC terminal receives one of a contention resolution message, a radio link control (RLC) acknowledgement (Ack), and an application-level Ack from the base station.

4. The data transmission method of claim 1, wherein the transmitting, by the MTC terminal, of the random access preamble message includes transmitting, by the MTC terminal, the random access preamble message after selecting the predetermined preamble from a dedicated first preamble group allocated to the MTC terminal.

5. The data transmission method of claim 4, wherein the transmitting, by the MTC terminal, of the random access preamble message includes transmitting, by the MTC terminal, the random access preamble message after selecting the predetermined preamble from a second preamble group allocated to a general terminal, if data to be transmitted by the MTC terminal is greater than a preset reference value.

6. The data transmission method of claim 1, wherein the transmitting, by the MTC terminal, of the random access preamble message includes selecting one of a dedicated preamble group allocated to the MTC terminal and a preamble group allocated to a general terminal by considering at least one of an amount of data to be transmitted by the MTC terminal and a length of a session to be set up.

7. A data transmission method for use in mobile communication systems, comprising:
receiving, by a base station, a random access preamble message from an MTC terminal;
transmitting, by the base station, a random access response message including UL resource allocation grant information as a response to the random access preamble message to the MTC terminal; and
receiving, by the base station, a scheduled transmission message including data of the MTC terminal from the MTC terminal.

8. The data transmission method of claim 7, further comprising:
receiving, by the base station, the scheduled transmission message from the MTC terminal, and transmitting one of a contention resolution message, an RLC Ack, and an application-level Ack to the MTC terminal.

9. The data transmission method of claim 7, wherein the transmitting, by the base station, of the random access response message includes allocating, by the base station, a dedicated radio network temporary identifier (RNTI) for the MTC terminal, and generating a radio bearer of the RNTI.

10. The data transmission method of claim 7, wherein the receiving, by the base station, of the scheduled transmission message includes transferring, by the base station, the data of the MTC terminal to a core network on the basis of preset bearer mapping information.
